(19) United States
(12) Patent Application Publication
(10) Pub. No.: US 2026/0263301 A1
(43) Pub. Date: Sep. 10, 2026

(54) BED APPARATUS AND TRANSPORTATION DEVICE

(71) Applicant: PARAMOUNT BED CO., LTD., Tokyo (JP)

(72) Inventors: Ryuhei YOKOTA, Tokyo (JP); Yuki NAKAMURA, Tokyo (JP); Kentaro KODAIRA, Tokyo (JP)

(21) Appl. No.: 19/256,503

(22) Filed: Jul. 1, 2025

(30) Foreign Application Priority Data
Mar. 7, 2025 (JP) 2025-036529

(51) Int. Cl. A61G 7/05; B60L 50/60; B60L 53/16

(52) U.S. Cl. CPC A61G 7/0528; B60L 50/60; B60L 53/16; A61G 2203/10

(57) ABSTRACT

A bed apparatus includes: a wheel; driving unit configured to transmit a driving force to the wheel; a user interface device; and a controller configured to control the driving unit according to an operation by the user interface device. The controller is configured to acquire a state of the bed apparatus, and restrict acceptance of an operation by the user interface device when the state of the bed apparatus thus acquired is a specific state.

### FIELD

The present disclosure relates to a bed apparatus and the like.

### BACKGROUND

For example, JP2008-119452a discloses a patient support apparatus, such as a hospital bed or a stretcher, that has a powered transport device such as a motorized wheel or a motorized traction drive for propelling the patient support apparatus along a floor.

### BRIEF DESCRIPTION OF THE DRAWINGS

FIG. 1 is a view illustrating a schematic (entire) bed apparatus in a first embodiment.

FIG. 2 is a view illustrating the schematic bed apparatus in the first embodiment.

FIG. 3 is a view illustrating a state of a connection unit of the bed apparatus in the first embodiment.

FIGS. 4A to 4C are views illustrating a schematic first operation device in the first embodiment.

FIG. 5 is a diagram illustrating a functional configuration in the first embodiment.

FIG. 6 is a diagram illustrating a software configuration in the first embodiment.

FIG. 7 is a diagram illustrating state transition of the bed apparatus in the first embodiment.

FIG. 8 is a diagram illustrating a processing flow in the first embodiment.

FIGS. 9A to 9C are diagrams illustrating an operation example in the first embodiment.

FIG. 10 is a diagram illustrating an operation example in a second embodiment.

FIG. 11 is a diagram illustrating a processing flow in a third embodiment.

FIG. 12 is a view illustrating a schematic bed apparatus in a fourth embodiment.

### DETAILED DESCRIPTION

One or more embodiments are now described with reference to the drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details (and without applying to any particular networked environment or standard).

As used in this disclosure, in some embodiments, the terms “component,” “system” and the like are intended to refer to, or comprise, a computer-related entity or an entity related to an operational apparatus with one or more specific functionalities, wherein the entity can be either hardware, or a combination of hardware and software in execution.

One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software stored on a non-transitory electronic memory or firmware that confers at least in part the functionality of the electronic components. While various components have been illustrated as separate components, it will be appreciated that multiple components can be implemented as a single component, or a single component can be implemented as multiple components, without departing from example embodiments. Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer-readable (or machine-readable) device or computer-readable (or machine-readable) storage/communications media having a computer program stored thereon. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Embodiments described herein can be exploited in substantially any wireless communication technology, comprising, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Z-Wave, Zigbee and other 802.XX wireless technologies and/or legacy telecommunication technologies.

In general, one aspect of the present application is a bed apparatus including: a wheel; a driving unit configured to transmit a driving force to the wheel; a user interface device; and a controller configured to control the driving unit according to an operation by the user interface device. The controller is configured to acquire a state of the bed apparatus, and restrict acceptance of an operation by the user interface device when the state of the bed apparatus thus acquired is a specific state.

Another aspect of the present application is a transportation device attachable to a bed apparatus. The transportation device includes: a wheel; a driving unit configured to transmit a driving force to the wheel; a user interface device; and a controller configured to control the driving unit according to an operation by the user interface device. The controller is configured to acquire a state of the bed apparatus, and restrict acceptance of an operation by the user interface device when the state of the bed apparatus thus acquired is a specific state.

In order for a staff or the like to transport a bed apparatus easily, a bed apparatus is known which is provided with a transportation device capable of travelling autonomously in response to operation of an operation device or provided with a transportation device for assisting the power of the staff or the like in moving the bed apparatus.

Here, in the movable bed apparatus, a power cable needs to be connected to an external power source at the time of charging a driving rechargeable battery of the transportation device. However, if the bed apparatus is moved during charging, the connected power cable is pulled, causing a risk of disconnection of the power cable or a risk of breakage of the outlet of the external power source. In addition, since the movement during charging is not assumed, the bed apparatus may be brought into contact with a device located around the bed apparatus. Further, there is a risk of an operator tripping over the power cable or the like.

Hereinbelow, a bed system, a bed apparatus, a control device, and an operation device for solving the one or multiple problems above will be described.

### 1. First Embodiment

### [1.1 Overall Configuration]

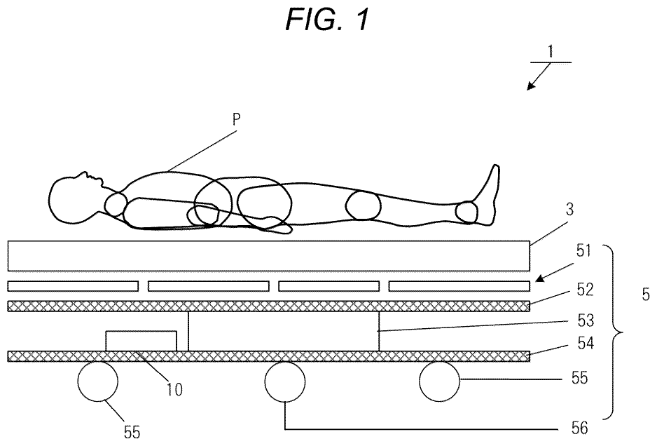

FIG. 1 is a view illustrating a schematic bed system 1 in this embodiment. As illustrated in FIG. 1, in the bed system 1, a mattress 3 is placed on a bed apparatus 5.

Note that, the mattress 3 may be an urethane mattress or an air mattress. Alternatively, the mattress 3 may be a hybrid mattress obtained by combining urethane and air cells. Still alternatively, the mattress 3 may be an elastic body used for bedding such as polyester fiber structure, gel, and spring.

The bed system 1 is used by a user P. For example, when the user lies on the bed apparatus 5 (mattress 3), the left side in FIG. 1 is a head side and the right side in FIG. 1 is a foot side. In addition, assuming the user P has a standard size, the back of the user P is located at the position of a back section, and the waist of the user is located at a curve section or a seat section.

Here, among those using the bed system, the user indicates a person actually using the bed apparatus 5, for example. For example, the user indicates a patient hospitalized in a hospital or facility, a care recipient, or a person lying on the bed apparatus 5 (mattress 3) at home.

In this embodiment, the staff indicates a person supporting the user. For example, the staff includes a medical staff such as a doctor and nurse in the hospital, a caring staff in the facility, a family member of the user at home, and the like.

In addition, in this embodiment, the operator indicates a person operating the bed system 1 (bed apparatus 5). The operator is mainly the staff, but includes the user when the user operates the bed system (bed apparatus).

Further, the body posture of the user in this embodiment includes the position of the user and the posture of the user. The position of the user is his/her position on the mattress 3 (sleeping position). The posture of the user is the posture of the user at the time of sleeping on the mattress 3 (sleeping posture). The body posture may also include his/her posture at the time of not sleeping, such as an edge sitting position or long sitting position.

### [1.2 Configuration of Bed Apparatus]

The configuration of the bed apparatus 5 will be described with reference to the drawings.

### [1.2.1 Overview]

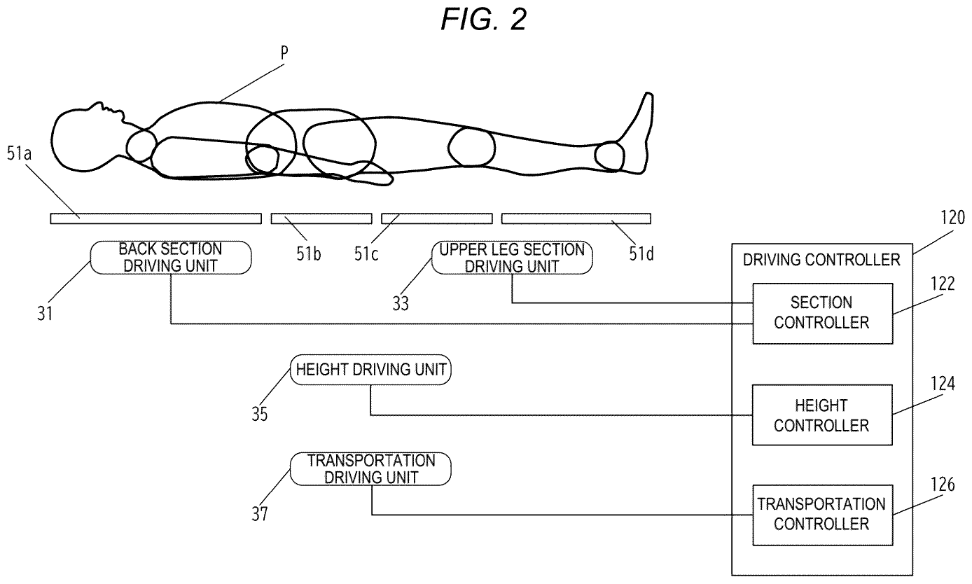

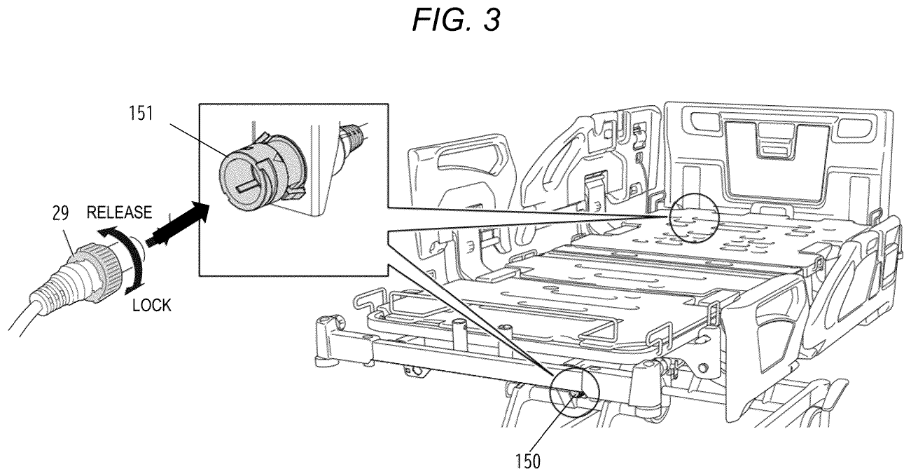

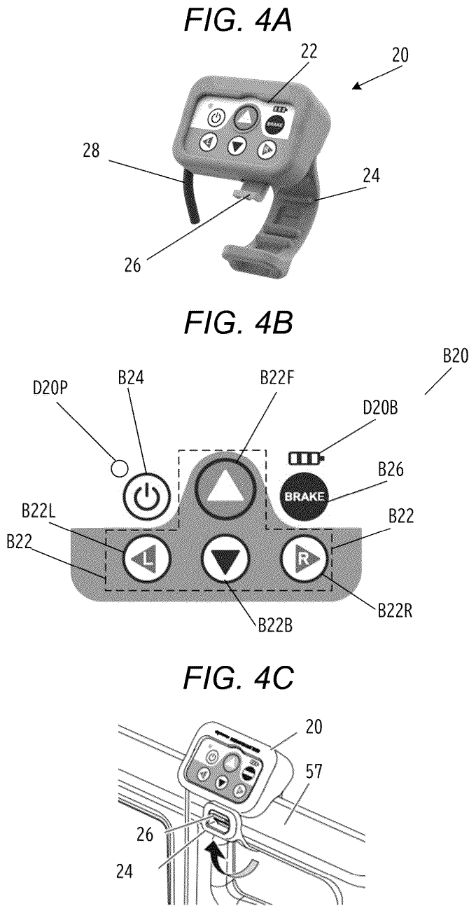

FIG. 2 is a view illustrating connection of driving units (drive device) of the bed apparatus 5. FIG. 3 is a view schematically illustrating connection of a control device 10 for controlling the bed apparatus 5 and an operation device for operating the bed apparatus 5. FIGS. 4A to 4C are enlarged view of a connection connector.

The bed apparatus 5 includes sections 51, an upper frame 52, and a lower frame 54 in the order from the top, and has a lifting mechanism 53 between the upper frame 52 and the lower frame 54. In addition, the lower frame 54 is provided with wheels 55. The wheels 55 are pivotally supported by the lower frame 54 so as to be rotatable, and include two wheels provided below the lower frame 54 so as to be away from each other in the lateral direction and longitudinal direction of the bed apparatus 5. For example, the wheels 55 may include four wheels provided near four corners of the lower frame 54. The wheels 55 are used for moving the general bed apparatus 5 and may be provided by using any publicly known method.

The bed apparatus 5 is also provided with a wheel 56, other than the wheels 55, which is movable in all directions. The wheel 56 may include a pair of wheels provided to each of the right and left of the lower frame 54. The wheel 56 may include one or multiple wheels. The wheel 56 is preferably an all-direction wheel, for example, and is preferably a mecanum wheel capable of moving in all directions, for example. Alternatively, the wheel 56 may be an omni wheel.

In addition, a transportation driving unit 37 is provided for driving the wheel 56. The transportation driving unit 37 is a motor for transmitting a driving force to the wheel 56. The transportation driving unit 37 may be located at a different location from the wheel 56, or may be provided in the wheel 56 as an in-wheel motor.

Further, the rotational shaft of the motor is coupled to the rotational shaft of the wheel 56, and the rotational velocity of the rotational shaft of the motor is equal to the rotational velocity of the wheel 56. Here, the moving velocity of the bed apparatus 5 can be calculated by detecting the number of revolutions of the motor.

As illustrated in FIG. 2, the sections 51 include a back section 51a, a seat section 51b, an upper leg section 51c, and a lower leg section 51d in the order from the head side to the foot side at the time when the user P is in a lateral position on the bed apparatus 5 (mattress 3). Here, each section of the sections 51 is turnable by itself or in conjunction with the others. In addition, each of the sections 51 may be a piece of plate-shaped member or may be a bendable member formed in an accordion shape by multiple members.

For example, in a case where the seat section 51b is a curved section, the seat section can support the user by bending along with ascension of the back section 51a. Alternatively, the seat section 51b may have a structure of extending or contracting while bending along with ascension or descension of the back section 51a.

Each of the sections is connected to a driving unit (a drive device such as an actuator), for example. The sections 51 are turnable in response to operation of the driving unit. Note that, the sections 51 do not necessarily have to be connected to driving units on a one-to-one correspondence, and one driving unit can cause multiple sections to operate by using a link mechanism, for example. In addition, the sections 51 operate in conjunction with each other by coupling adjacent sections.

Further, by turning the sections, the bed apparatus 5 implements operations such as a back raising operation, an upper-leg raising operation, and a foot lowering operation. The bed apparatus 5 may cause the back raising operation and the upper-leg raising operation (foot lowering operation) to operate in conjunction with each other.

The sections 51 are supported by the upper frame 52. The upper frame 52 may have any shape that supports the sections 51. In addition, the lower frame 54 may have any shape that supports the upper frame 52 supporting the sections 51.

The lifting mechanism 53 is for adjusting the height of the upper frame 52 and configured to adjust the height (floor height) of the bed apparatus 5. Here, the height of the bed apparatus 5 generally indicates a height (floor height) from a surface (ground surface) on which the bed apparatus is placed to the upper frame 52. Note that, the height of the bed apparatus 5 may be a height from the ground surface to the sections 51.

The lifting mechanism 53 is implemented by the drive device (drive mechanism) such as a link mechanism and an actuator.

The driving units are described based on FIG. 2. A back section driving unit 31 can raise the back section 51a. For example, the back section driving unit 31 is an actuator, and connects the back section 51a to the tip of the rod of the actuator via the link mechanism.

An upper leg section driving unit 33 can raise the upper leg section 51c. For example, the upper leg section driving unit 33 is an actuator, and connects the upper leg section 51c to the tip of the rod of the actuator via the link mechanism.

In addition, each driving unit is connected to a driving controller 120. The driving controller 120 functions as: a section controller 122 that controls the back section driving unit 31 and the upper leg section driving unit 33; a height controller 124 that controls a height driving unit 35; and a transportation controller 126 that controls the transportation driving unit 37.

The section controller 122 implements a back raising function and raises the back section 51a by controlling the back section driving unit 31.

The section controller 122 implements an upper leg raising function and raises the upper leg section 51c by controlling the upper leg section driving unit 33. Note that, by application of a driving force, the upper leg section 51c turns about the seat section 51b side of the upper leg section 51c as a fulcrum, so that the lower leg section 51d side of the upper leg section 51c is raised. At this time, the lower leg section 51d may turn in conjunction with the upper leg section 51c.

Meanwhile, the height controller 124 implements a function of raising or lowering the bed apparatus 5 and can locate the upper frame 52 at a high or low position by controlling the height driving unit 35.

Note that, each driving unit performs a reverse operation to the above operation when the driving controller 120 controls the driving unit so that it performs the reverse operation. In other words, by inserting or retracting a rod of the actuator, the driving units perform operations such as a back lowering operation, an upper-leg lowering operation, and a floor-height lowering operation.

By controlling the transportation driving unit 37, the transportation controller 126 transmits, to the wheel 56, a driving force for moving the bed apparatus 5 and assisting movement of the bed apparatus 5. Here, the transportation controller 126 can switch its mode between a first transportation mode and a second transportation mode.

In the first transportation mode, upon being operated by a first operation device 20, the transportation driving unit 37 generates a driving force in response to an operation signal and drives the wheel 56. In the second transportation mode, when no operation is made by the first operation device 20 and the staff is pushing the bed apparatus 5, the transportation driving unit generates a driving force for assisting the staff in pushing the bed apparatus 5 and drives the wheel 56.

Here, in the first transportation mode, the transportation driving unit 37 (motor) is actuated and generates a driving force so that the bed apparatus 5 can travel by itself. The driving force thus generated is transmitted to the wheel 56 and the wheel is rotated, so that the bed apparatus 5 moves. Meanwhile, in the second transportation mode, the transportation driving unit 37 is actuated and generates a driving force enough to assist the staff in pushing the bed apparatus 5.

Thus, in the case of moving the bed apparatus 5, for example, since the bed apparatus 5 is so heavy that the staff finds it hard to move the bed apparatus 5 when starting moving it, by operating an operation button B20 (movement button B22) of the first operation device 20, the bed apparatus 5 moves by itself in a direction of the movement button B22 thus operated. Meanwhile, after the bed apparatus 5 starts moving, by pushing the bed apparatus 5 without operating the first operation device 20, the staff can cause the transportation driving unit 37 to generate a driving force for assisting the staff according to the amount of pushing force the staff applied.

The driving force to be generated by the transportation driving unit 37 may be different between the first transportation mode and the second transportation mode, or may be different depending on the direction of movement. Thus, the movement speed of the bed apparatus 5 is preferably within the following range, for example.

First transportation mode: forward movement 0.5 m/s to 0.7 m/s, backward movement 0.35 m/s to 0.55 m/s, lateral movement 0.1 m/s to 0.3 m/s

Second transportation mode: forward movement 0.9 m/s to 1.1 m/s, backward movement 0.9 m/s to 1.1 m/s, lateral movement 0.9 m/s to 1.1 m/s

The movement speed is merely an example and may be able to be changed by the operator. In addition, the movement speed of the bed apparatus 5 may be other than the above speed.

In the first transportation mode, the staff can move the bed apparatus 5 in the direction of the movement button B22 of the first operation device 20 by merely operating the movement button B22. Meanwhile, in the second transportation mode, while the staff is pushing the bed apparatus 5, the transportation driving unit 37 is actuated and the driving force thus generated is transmitted to the wheels 55 for the purpose of assisting the pushing force. This enables the staff to move the bed apparatus 5 with a light force by application of the driving force from the transportation driving unit 37 to his/her original force.

The transportation driving unit 37 may also have a brake function. For example, when a brake is on, the transportation driving unit 37 may lock the wheels (or make the wheels hard to rotate by applying an excessive load on the wheels) to make the bed apparatus 5 immovable.

In other words, the bed apparatus 5 of the present disclosure enables the staff to transport the bed apparatus 5 easily by switching the mode between the first transportation mode and the second transportation mode. Here, for the second transportation mode, techniques of providing an assist unit or the like for assisting transportation to the bed apparatus 5 can be used, such as JP2006-087598A (ELECTRIC CARRIER FOR BED, Filing Date: Sep. 22, 2004), JP 2006-000328A (ELECTRIC CARRIER FOR BED AND DRIVING CONTROL METHOD THEREFOR, Filing Date: Jun. 16, 2004), and JP 2004-194844A (ELECTRIC CARRIER IN BED AND DRIVING CONTROL METHOD THEREFOR, Filing Date: Dec. 17, 2002), and the contents of these applications may be incorporated by reference.

Note that, the driving controller 120 may have two configurations including a first driving controller that includes the section controller 122 and the height controller 124 and a second driving controller that includes the transportation controller 126. In this case, the first operation device 20 to be described below can control the second driving controller and a second operation device 30 to be described below can control the first driving controller.

### [1.2.2 Operation Device]

Next, the operation device will be described. In this embodiment, the first operation device 20 for operating movement of the bed apparatus 5 and the second operation device 30 for performing operations of the bed apparatus 5 (such as a section operation and a height operation) can be connected to the control device 10 that controls the bed apparatus 5.

FIG. 3 is a view schematically illustrating a state observed when the first operation device 20 is connected to a connector. For example, a first connection unit 140 and a second connection unit 150 may have connection members respectively provided on the head side and the foot side of the upper frame of the bed apparatus 5. For example, FIG. 3 is an enlarged view of a connection member 151 of the second connection unit 150.

By connecting a connector 29 being a connection terminal to the connection member 151, the first operation device 20 is connected to the bed apparatus 5 (control device 10). Thereby, an operation signal from the first operation device 20 can be input to the control device 10. Note that, the connector of the first operation device 20 and any of the first connection unit 140 and the second connection unit 150 are mating connectors, such as a female connector and a male connector, and may be detachable from each other.

FIGS. 4A to 4C illustrate an example of the first operation device 20. As illustrated in FIG. 4A, the first operation device 20 includes: an operation panel 22; a belt 24 as an attachment member; and a lock member 26. In addition, the first operation device 20 is connected to the control device 10 via a cable 28. The operation panel 22 has multiple operation buttons B20.

FIG. 4B is a view illustrating an example of the operation panel 22. For example, the operation panel 22 has movement buttons B22 corresponding to four directions that correspond to movement directions of the bed apparatus 5:
a forward movement button B22F as a first operation button for movement in the forward direction;
a backward movement button B22B as a second operation button for movement in the backward direction;
a rightward movement button B22R as a third operation button for movement in the rightward direction; and
a leftward movement button B22L as a fourth operation button for movement in the leftward direction.

Here, the above shows the four directions as an example of the movement buttons B22 corresponding to the movement directions, but the number of directions may be more than or less than the four directions. For example, the number of directions may be two including the forward and backward directions (leftward and rightward directions) or may be eight including directions oblique to the upward, downward, leftward, and rightward directions.

The operation panel may also have an operation button other than the movement buttons B22 corresponding to the movement directions. For example, in FIG. 4B, the operation panel includes:
a power button B24 as a fifth operation button for turning power on or off; and
a brake button B26 as a sixth operation button for making the bed apparatus 5 immovable (braking the bed apparatus 5).

The operation panel may also have a notification means other than the operation buttons B20. For example, the notification means may be a sound output means such as a buzzer and voice, or may be means such as light, display, and voice. For example, in FIG. 4B, the operation panel includes:
a power lamp D20P as a first notification means indicating that power is on; and
a remaining amount lamp D20B as a second notification means indicating a state of the remaining amount of battery of the first operation device 20.

Note that, in this embodiment, the operation buttons B20 are hardware buttons in consideration of the operator's operability (for allowing the operator to easily feel a sense of manipulating the buttons). However, the operation buttons B20 may be software buttons using a touch panel, for example.

FIG. 4C illustrates an operation example of attaching the first operation device 20 to the bed apparatus 5. For example, a case of providing the first operation device to a frame 57 of a head board (foot board) provided on the head side (foot side) of the bed apparatus 5 will be described.

The first operation device 20 is disposed on the frame 57. Then, the belt 24 is wound around the frame 57 to mount the first operation device 20 on the frame 57. Then, the belt 24 is fixed by the lock member 26.

Note that, another method is conceivable as a method of fixing the first operation device 20 on the bed apparatus 5. For example, a dedicated attachment member may be provided on the foot board or head board so that the first operation device 20 can be easily attached thereto and detached therefrom. Alternatively, for example, a magnet or the like may be provided on the first operation device 20 to fix the first operation device on the frame 57 using a magnetic force.

In addition, a third connection unit 160 can be connected to the second operation device 30. The second operation device 30 can perform an operation of controlling the back section driving unit 31, the upper leg section driving unit 33, and the height driving unit 35 of the bed apparatus 5.

Note that, the second operation device 30 and the first operation device 20 may be integrated into one device. Alternatively, the first operation device 20 may be a touch panel or the like to function as the second operation device 30.

### [1.2.3 Functional Configuration]

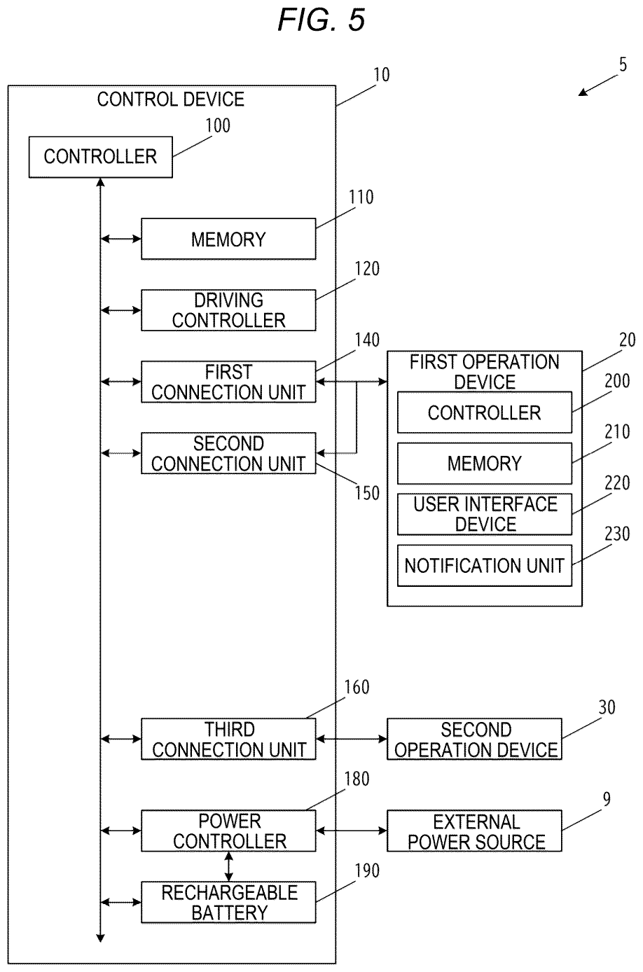

Subsequently, functional configurations of the control device 10 and the first operation device 20 will be described with reference to FIG. 5.

A controller 100 is configured to control the entire control device 10. The controller 100 implements various functions by reading and executing various programs stored in a memory 110 (such as a storage or ROM). The controller 100 may be implemented by one or multiple control devices/calculation devices (a central processing unit (CPU) and a system on a chip (SoC)). In addition, the controller 100 may include one or multiple control circuits.

The memory 110 stores programs, data, and the like. For example, the memory 110 may be a storage, a ROM, a RAM, or the like. In addition, the memory 110 may have a configuration including a cache memory and the like included in other functional units (such as the controller 100 and the driving controller 120).

Here, the storage is a nonvolatile storage device that can store the programs and the data. For example, the storage may be a storage device such as a hard disk drive (HDD) and a solid state drive (SSD). Alternatively, the storage may be an externally connectable USB memory. Still alternatively, the storage may be, for example, a storage area on a cloud.

The ROM is a nonvolatile memory that is capable of keeping the programs and the data even when power is turned off. The RAM is a main memory that is mainly used by the controller 100 when executing the processing. The RAM is a rewritable memory that temporarily keeps the programs read from the storage and the ROM and the data including results at the time of execution of the processing.

As illustrated in FIG. 2, the driving controller 120 is configured to control the drive device. For example, the driving controller 120 controls the driving units such as the back section driving unit 31, the upper leg section driving unit 33, the height driving unit 35, and the transportation driving unit 37.

The first connection unit 140 and the second connection unit 150 are connection units to which the first operation device 20 can be connected. Meanwhile, the third connection unit 160 is a connection unit to which the second operation device 30 can be connected. These connection units may have any form of connection by which these operation devices can be connected. For example, the connection units may be connectors that are capable of transmitting and receiving electric signals or may use existing techniques such as universal serial bus (USB) and RS-232C. Note that, in FIG. 5, the number of connection units to which the first operation device 20 can be connected is two, but may be one or three or more.

A power controller 180 is configured to detect a charging state of a rechargeable battery 190 which is a secondary battery and control supply of power to the rechargeable battery 190 based on the detected state. In addition, the power controller 180 can be connected to an external power source 9 through a power cable. In other words, the rechargeable battery 190 is charged by the external power source 9 via the power controller 180. The power controller 180 functions as a charger that performs control to charge the rechargeable battery 190.

The functional units of the bed apparatus 5 are operated based on power supplied from the rechargeable battery 185. Here, the rechargeable battery 185 may be any of secondary batteries such as a lead battery, a lithium ion battery, a nickel-hydrogen battery, and a nickel-cadmium battery. Note that, the device driven by the first operation device 20 (such as the transportation driving unit 37) and the device operated by the second operation device 30 (such as the back section driving unit 31, the upper leg section driving unit 33, and the height driving unit 35) may be supplied with power from different rechargeable batteries.

Note that, the first operation device 20 that can be connected to any of the first connection unit 140 and the second connection unit 150 may include: a controller 200; a memory 210; a user interface device 220; and a notification unit 230. The controller 200 and the memory 210 have the same configurations as the controller 100 and the memory 110.

The user interface device 220 is a unit that accepts an operation by the operator, and includes the operation buttons B20 described in FIG. 4, for example.

The notification unit 230 is a unit that notifies the operator and the like of various states, and is implemented by light (such as an LED lamp), sound (such as a buzzer and voice), vibrations, and the like, for example.

Note that, a display may be provided instead of the notification unit 230. Alternatively, the user interface device 220 and the notification unit 230 may be integrally formed by using a touch panel as the display.

### [1.2.4 Software Configuration]

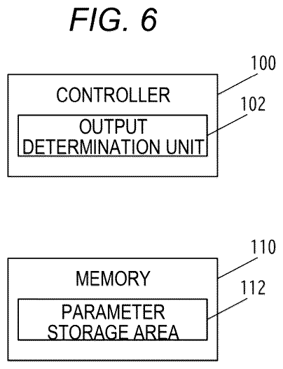

A configuration of software will be described with reference to FIG. 6.

The controller 100 functions as an output determination unit 102 by reading a program stored in the memory 110 and executing the program.

The output determination unit 102 is configured to determine motor output included in a control signal to be output to the motor of the transportation driving unit 37. The output determination unit 102 determines motor output as a driving force according to the first transportation mode and the second transportation mode.

In the first transportation mode, the output determination unit 102 determines motor output previously determined according to the operation buttons B20. Note that, in the first transportation mode, the staff may be able to change output such as “weak”, “medium”, and “strong”.

Meanwhile, in the second transportation mode, the output determination unit 102 may adjust motor output so that a transportation force is equal to addition of a human operation force and motor output determined according to input.

Then, the controller 100 generates a control signal based on a motor output value determined by the output determination unit 102 and a movement direction determined based on input from the operation button B20 and the attachment position of the first operation device 20.

Meanwhile, the memory 110 secures an area for a parameter storage area 112 that stores therein setting values and parameter values.

### [1.3 State Transition]

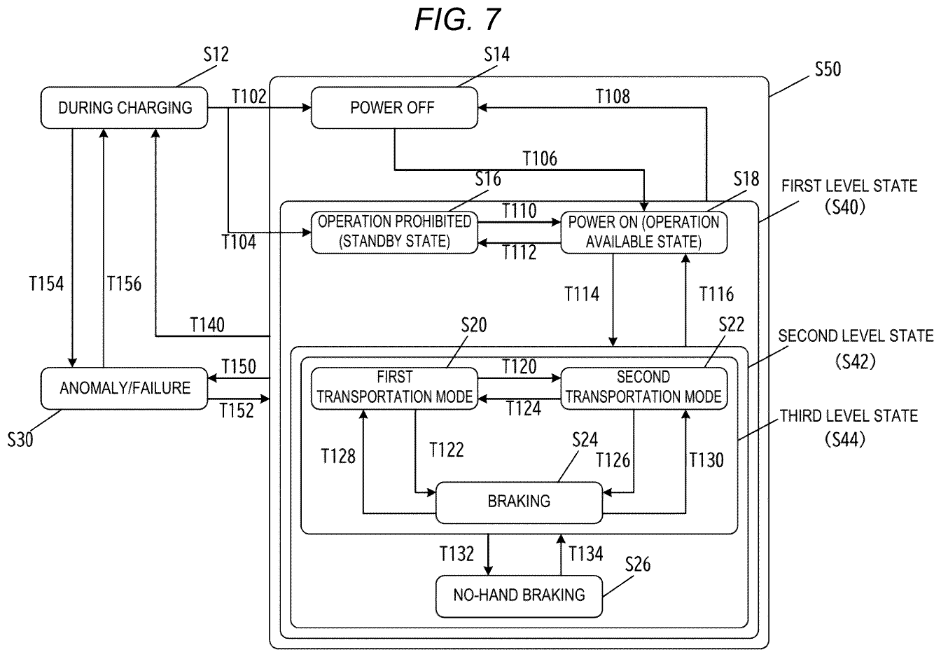

Next, state transition of the bed apparatus 5 in this embodiment will be described with reference to FIG. 7. Note that, states of the bed apparatus 5 in this embodiment include: a charging state (S12); a power off state (S14); an anomaly/failure state (S30); and a first level state (S40). The first level state is a state in which the first operation device 20 is acceptable and the control device 10 assists the operator when the operator transports the bed apparatus 5.

In addition, the first level state (S40) includes: an operation prohibited (S16) state; a power on (S18) state; and a second level state (S42). The operation prohibited state is a standby state, and the power on state is an operation acceptable state. The second level state (S42) indicates a state in which the control device 10 can assist the bed apparatus 5.

The second level state (S42) includes a third level state (S44) and a no-hand braking state (S26). The third level state (S44) indicates a state in which the bed apparatus 5 can be operated by the first operation device 20.

The third level state (S44) includes: a first transportation mode state (S20); a second transportation mode state (S22); and a braking state (S24).

### (1) Charging State (S12)

First, the controller 100 sets the bed apparatus in the charging state (S12) when the power cable is connected and the rechargeable battery 185 is charged by the power controller 180. To put it another way, irrespective of which of the states included in a non-charging state (S50) the bed apparatus 5 is in, the controller 100 causes the state of the bed apparatus to transition to the charging state (S12) once the power cable is connected and the rechargeable battery 185 starts being charged by the power controller 180 (T140). Note that, here, the non-charging state indicates a state in which the battery is not being charged and no anomaly/failure occurs. Further, the charging state indicates a state in which the battery is being charged or stands by for charging. For example, when the rechargeable battery 185 is fully charged, the battery is set in a charging standby state; however, since charging is still available, this state is also included in the charging state in this embodiment.

If the remaining amount of rechargeable battery is smaller than a predetermined value (smaller than 10%, for example) when the power cable is detached, the controller 100 causes the bed apparatus 5 to transition to the power off state (T102). On the other hand, if the remaining amount of rechargeable battery is equal to or larger than the predetermined value (equal to or larger than 10%, for example) when the power cable is detached, the controller 100 causes the bed apparatus 5 to transition to the operation prohibited state (S16).

In this manner, when returning from the charging state (transitioning to the non-charging state), the bed apparatus 5 is preferably set to the operation prohibited state (S16) once (T104). This can prevent the bed apparatus 5 from becoming the state of being able to travel by itself even if the operator erroneously operates the bed apparatus when the bed apparatus returns from the charging state.

Alternatively, when returning from the charging state (transitioning to the non-charging state), the bed apparatus 5 may be set to the power off state (S14). In this case, since the user needs a predetermined operation for causing the bed apparatus 5 to transition to the power on state, it is possible to provide the bed apparatus with enhanced safety.

Still alternatively, when returning from the charging state (transitioning to the non-charging state), the bed apparatus 5 may be set to the power on state (S18). In this case, since the bed apparatus has already transitioned to the power on state, the user can operate the bed apparatus right away. Thus, it is possible to provide the bed apparatus 5 with enhanced convenience for the operator.

Still alternatively, the operator or administrator may be able to set to which state the bed apparatus returns when the bed apparatus returns from the charging state (transitions to the non-charging state). This makes it possible to manage the bed apparatus 5 based on decision on which of safety and convenience is prioritized made according to the installation location of the bed apparatus 5 and the operator's experience level.

### (2) Power Off State (S14)

The power off state (S14) is a state in which the bed apparatus 5 is powered off. Here, when a predetermined operation is made to the power button B24 in the power off state by the operator, the bed apparatus transitions to the power on state (S18) (T106). Here, as an example of the predetermined operation, the power button B24 may be pressed long for a predetermined period of time (such as one second or two seconds). As another example of the predetermined operation, the power button B24 may be pressed multiple times (pressed multiple times such as twice or three times in a short period of time consecutively).

Meanwhile, when a predetermined condition is satisfied in the first level state (S40), the bed apparatus transitions to the power off state (T108). Here, the following conditions are conceivable as the predetermined condition, for example.
The power button B24 is selected for a predetermined period of time or longer. Here, the predetermined period of time may be a period of time longer than that of T106. For example, the predetermined period of time mentioned here may be two seconds or longer.
In a case where a no-operation state or a no-movement state lasts for a predetermined period of time or longer. For example, when the no-operation state or the no-movement state lasts for 300 seconds or longer, the controller 100 may cause the state to transition to the power off state.
In a case where the remaining amount of rechargeable battery becomes smaller than a predetermined value. For example, when the remaining amount of rechargeable battery becomes smaller than 5%, the controller 100 may cause the state to transition to the power off state.

### (3) Operation Prohibited State (S16)

The operation prohibited state (S16) is a state in which the bed apparatus 5 is in a standby state. In other words, the standby state is a state in which the bed apparatus does not accept any operation even if the first operation device 20 is operated, for example.

Here, when the operation button B20 is selected as an example of a predetermined operation, the controller 100 may cause the state to transition from the operation prohibited state (S16) to the power on state (S18) (T110). Here, the predetermined operation may be an operation of pressing the power button B24 once, or alternatively may be an operation of pressing the power button B24 twice.

This embodiment will be described with the power button B24 as an example of the operation button B20; however, another different operation button B20 such as an operation prohibition button may be provided so that this operation button B20 is operated instead of the power button B24.

### (4) Power On State (S18)

The power on state (S18) is a state in which the bed apparatus 5 is powered on, and is a state in which the operator can operate the bed apparatus 5 via the first operation device 20, for example.

When a predetermined condition is satisfied in the power on state (S18), the controller 100 causes the state of the bed apparatus 5 to transition to the first level state (S40). Here, the following conditions are conceivable as the condition for causing the state to transition from the power on state (S18) to the first level state (S40).
The operation button B20 (any of the upward, downward, leftward, and rightward movement buttons B22) is selected
The brake button B26 is selected
The wheel 56 is rotated

Meanwhile, when the power button B24 is selected again in the power on state (S18), the state transitions to the operation prohibited state (S16) again (T112). In addition, the controller 100 may cause the state to transition to the operation prohibited state (S16) when a no-operation state or a no-movement state lasts for a predetermined period of time (such as 60 seconds) (T112).

### (5) Second Level State (S42)

The second level state (S42) is a state in which the bed apparatus 5 can travel by itself and includes the third level state (S44). In the third level state (S44), the controller 100 can switch the state among the first transportation mode state (S20), the second transportation mode state (S22), and the braking state (S24) according to an operation by the operator.

### (6) First Transportation Mode State (S20)

Once the movement button B22 (any of the upward, downward, leftward, and rightward movement buttons B22) is selected by the operator, the controller 100 causes the state of the bed apparatus 5 to transition to the first transportation mode state (S20). In the first transportation mode state (S20), the control device 10 controls the bed apparatus 5 in the first transportation mode.

In the first transportation mode state (S20), if the movement button B22 is not selected and the rotation of the wheel 56 is accelerated or the movement speed detected based on the rotation of the wheel 56 is equal to or larger than a predetermined speed, the controller 100 causes the state of the bed apparatus 5 to transition to the second transportation mode state (S22) (T120).

Meanwhile, when the brake button B26 is selected in the first transportation mode state (S20), the controller 100 causes the state of the bed apparatus 5 to transition to the braking state (S24) (T122). Note that, when the multiple operation buttons are selected at the same time in the first transportation mode state (S20), the controller 100 may cause the state of the bed apparatus 5 to transition to the braking state (S24) as in the case where the brake button B26 is selected (T122).

### (7) Second Transportation Mode State (S22)

In the second transportation mode state (S22), the control device 10 controls the bed apparatus 5 in the second transportation mode. When the movement button is selected again in the second transportation mode state (S22), the controller 100 causes the state of the bed apparatus 5 to transition to the first transportation mode state (S20) (T124).

Meanwhile, when the brake button B26 is selected in the second transportation mode state (S22), the controller 100 causes the state of the bed apparatus 5 to transition to the braking state (S24) (T126). Note that, when the multiple operation buttons are selected at the same time in the second transportation mode state (S22), the controller 100 may cause the state of the bed apparatus 5 to transition to the braking state (S24) as in the case where the brake button B26 is selected (T126).

### (8) Braking State (S24)

The braking state is a state of stopping the bed apparatus 5 by actuating the brake by control over the transportation driving unit 37. The controller 100 decelerates the speed of the bed apparatus 5 by controlling the transportation driving unit 37 so that a load is applied on the wheel 56. Then, once the bed apparatus 5 is stopped completely, the controller 100 keeps the stopped state of the bed apparatus 5 by applying a load on the wheel 56.

Here, when selection of the brake button B26 is released and the movement button B22 (any of the upward, downward, leftward, and rightward movement buttons B22) is selected, the controller 100 causes the state of the bed apparatus 5 to transition to the first transportation mode state (S20) (T128).

### (9) No-Hand Braking State (S26)

If the brake button B26 is not selected and deceleration is detected from the wheel 56 in any of the states of the third level state (S44), the controller 100 causes the state of the bed apparatus 5 to transition to the no-hand braking state (S26) (T132).

In addition, in the no-hand braking state (S26), the controller 100 causes the state of the bed apparatus 5 to transition to any of the states of the third level state (S44) according to the operation and the state of the wheel 56 (T134).

Here, the no-hand braking state may be a state in which regenerative braking of the wheel 56 is generated, for example. In addition, in the case of no-hand braking, a braking torque is generated in the motor by stopping supply of power to the transportation driving unit 37 (motor) that drives the wheel 56, for example. This braking torque generates a braking effect for decelerating the bed apparatus 5.

When the state becomes the no-hand braking state, by setting the driving force so that the assistance ratio of the transportation driving unit 37 does not become 100% in the second transportation mode, for example, deceleration in the number of revolutions of the wheel is determined once hands are released, thus implementing the function of letting the bed apparatus 5 stop without traveling by itself.

For example, once the movement button B22 (any of the upward, downward, leftward, and rightward movement buttons B22) is selected, the controller 100 causes the state of the bed apparatus 5 to transition to the first transportation mode state (S20). Meanwhile, when acceleration of the wheel 56 is detected, the controller 100 causes the state of the bed apparatus 5 to transition to the second transportation mode state (S22). Meanwhile, when the brake button B26 is selected, the controller 100 causes the state of the bed apparatus 5 to transition to the braking state (S24).

Meanwhile, if none of the operation buttons B20 is selected and the wheel 56 is stopped in the no-hand braking state (S26), the controller 100 may cause the state of the bed apparatus 5 to transition to the power on state (S18) (T116).

### (10) Anomaly/Failure State (S30)

The anomaly/failure state (S30) is a state in which an anomaly/failure of the bed apparatus 5 occurs. For example, if any anomaly or failure of the bed apparatus 5 is detected in any of the states included in S50, the controller 100 causes the state of the bed apparatus 5 to transition to the anomaly/failure state (S30) (T150).

In the anomaly/failure state (S30), for example, the controller 100 may give notification of anomaly contents or failure contents. In addition, the controller 100 may give notification of a countermeasure against the anomaly/failure contents.

When the anomaly/failure detected in the bed apparatus 5 is solved, the controller 100 may return the state of the bed apparatus 5 to the state the bed apparatus has been in before the anomaly/failure occurs (T152).

Meanwhile, when an anomaly/failure is detected in the charging state (S12), the controller 100 causes the state of the bed apparatus 5 to transition to the anomaly/failure state (S30) (T154). Also in this case, when the anomaly/failure is solved, the controller 100 may return the state of the bed apparatus 5 to the state the bed apparatus has been in before the anomaly/failure occurs (T156).

### [1.4 Processing Flow]

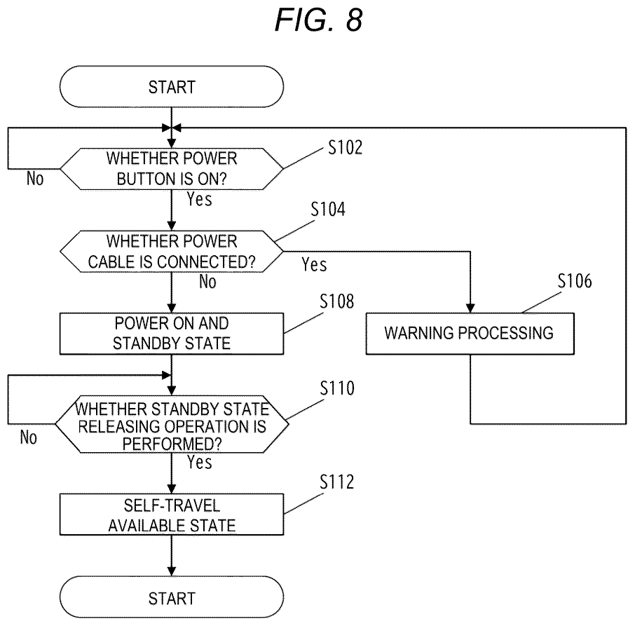

Subsequently, a processing flow in this embodiment will be described with reference to the drawings. Note that, FIG. 8 illustrates an example of a flow for describing processing to be executed by the controller 100 in this embodiment. The overall transition of the state of the bed apparatus 5 has been described in FIG. 7; in this description, the transition of the state using the processing flow will be described.

The controller 100 stands by until the power button B24 is selected (S102; No). Then, once the power button B24 is selected (S102; Yes), the controller 100 determines whether the power cable is connected to the connector (S104). In other words, if the power cable is connected to the connector for supplying power in the bed apparatus 5, the controller determines that the bed apparatus 5 is in a specific state.

Here, if the power cable is connected (S104; Yes), the controller 100 executes warning processing (S106) and moves the processing to S102. Specifically, the controller 100 detects that the power cable is connected to the connector. Here, in the warning processing, warning may be output to the operator by outputting an alarm sound or turning on warning light, for example. Meanwhile, in the warning processing, if the first operation device 20 can display a display screen, a message may be displayed on the display screen.

If determining that the power cable is not connected (S104; No), the controller 100 powers on the bed apparatus 5 and causes the state to transition to the standby state (S108). In other words, in S108, the controller 100 may cause the state of the bed apparatus 5 to transition to the operation prohibited state (S16) having been described in FIG. 7.

Then, if determining that a standby state releasing operation is performed (S110; Yes), the controller 100 causes the state to transition to the self-travel available state (S112). In other words, in S112, the controller 100 may cause the state of the bed apparatus 5 to transition to the power on state (S18) having been described in FIG. 7 to move it to the second level state (S42).

In this way, according to the processing in FIG. 8, when the power cable is connected to the bed apparatus 5, the movement of the bed apparatus 5 can be restricted. This can prevent the operator from making the bed apparatus 5 travel by itself erroneously even when the bed apparatus 5 is being charged and the power cable is connected.

Note that, although the controller 100 judges in S104 whether the power cable is connected in this embodiment, the controller 100 may judge another state. For example, the controller 100 may judge whether the rechargeable battery 185 is being charged.

### [1.5 Operation Example]

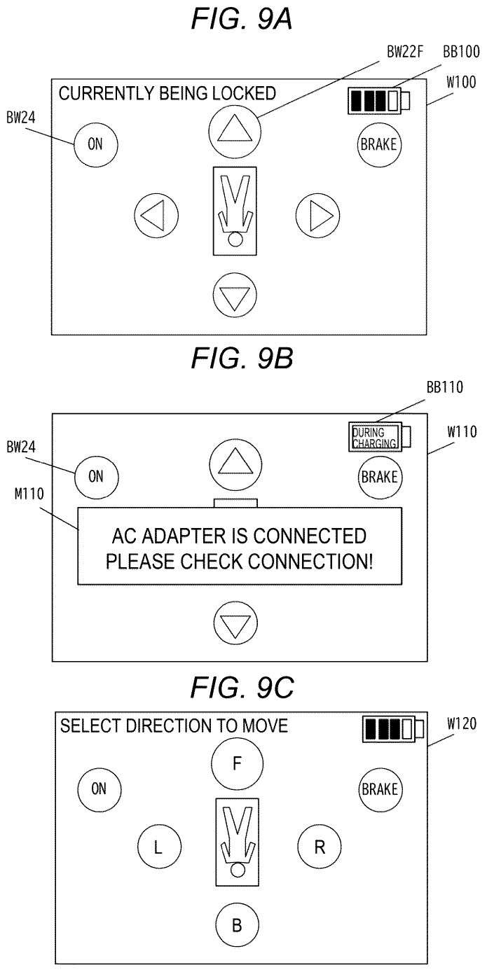

Next, an operation example will be described. FIGS. 9A to 9C are diagrams illustrating the operation example in this embodiment. FIGS. 9A to 9C illustrate an example of a case where the first operation device 20 is a device capable of displaying a display screen.

FIG. 9A illustrates an example of a display screen W100 in a case where the power cable is not connected. For example, a battery charge display BB100 indicates the current remaining amount of rechargeable battery 185. In addition, the display screen W100 is a display screen observed when the power cable is detached, and is a display screen indicating the operation prohibited state (standby state). At this time, since the operator cannot operate the bed apparatus, a message of “currently being locked” is displayed on the display screen. This makes the operator know that he/she cannot operate the bed apparatus 5. For example, even when the operator selects a forward movement button BW22F, the bed apparatus 5 does not move. In the state of FIG. 9A, the operator needs to press a power button BW24 once to cause the state of the bed apparatus 5 to transition to the power on state before operating the bed apparatus.

FIG. 9B illustrates an example of a display screen W110 in a case where the operation button is operated while the power cable is connected. A battery charge display BB110 displays information that the power cable is connected and the battery is being charged. In addition to the battery charge display BB110, the controller 100 may also give notification that the battery is being charged using a buzzer or voice.

Here, when the power button BW24 is selected by the operator, the controller 100 executes the warning processing since the power cable is connected. For example, the controller 100 may display a message M110 of “AC adapter is selected/please check connection!”. This enables the operator to easily know that the power cable is connected to the bed apparatus 5 and therefore the bed apparatus 5 is unable to move.

Note that, the way of description in the display screen may be changed to any description and may be changed according to the destination. For example, FIG. 9C illustrates an example of a display screen W120 in the power on state (operation available state). For example, in FIG. 9C, the operation buttons are displayed such as “F” (forward) and “B” (backward).

In addition, since FIG. 9C illustrates the power on state (operation available state), a message of “select direction to move” is displayed on the display screen W120. The operator can execute the processing according to the states having been described in FIG. 7 by selecting any of the operation buttons B20 or pressing the bed apparatus 5 by hands.

### [1.6 Effects]

According to this embodiment, when the power cable is connected to the bed apparatus 5, the movement of the bed apparatus 5 can be prohibited. This can prevent an accident where the power cable is kept inserted when the bed apparatus 5 is moved.

Specifically, when the bed apparatus 5 is in the specific state, an operation by the first operation device 20 is restricted. For example, it is assumed that the specific state is one in which the power cable is connected to the connector. In this case, when the power cable is connected to the connector, since the battery is being charged, the state of the bed apparatus 5 does not transition to any state in S50 as illustrated in FIG. 7. Thus, an operation by the first operation device 20 is not acceptable and is restricted.

Meanwhile, when the bed apparatus 5 is released from the specific state, e.g., when the power cable is detached from the connector and the battery is no longer being charged, the state does not transition to the power on state which is the operation available state directly but transitions to the operation prohibited state in T104 of FIG. 7. This brings about an effect such that, when the power cable is detached from the connector, the operator cannot move the bed apparatus 5 unless he/she performs an operation of releasing the standby state.

As a method of determining whether or not the power cable is detached from the connector, for example, it may be determined by a voltage and current from the external power source and determined that the power cable is detached from the connector when power is no longer fed, or it may be determined that the connector is disconnected physically. For example, a dedicated power cable equipped with a connection switch may be used. For example, once the dedicated power cable is inserted into an outlet, the controller 100 acquires a state in which the connection switch is physically pressed. Then, by determining that the connection switch is detached (released from the pressed state), the controller 100 can judge the physical connection.

### 2. Second Embodiment

In the first embodiment, whether the bed apparatus 5 is in the specific state that does not accept any operation has been determined based on whether the power cable is connected. In this embodiment, an embodiment in which the bed apparatus 5 acquires multiple states and makes determination by using the multiple states in combination will be described.

Note that, the functions and configurations of the second embodiment are the same as those having been described in the first embodiment and therefore detailed description thereof will be omitted. Hereinbelow, the contents specific to this embodiment will be mainly described.

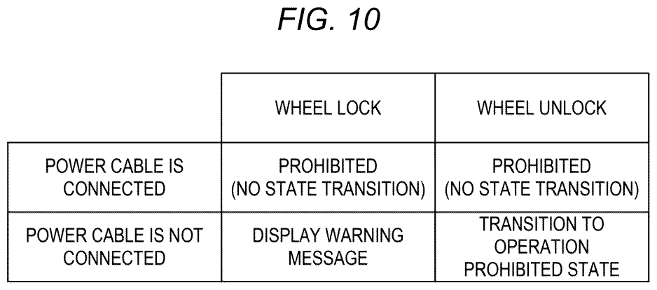

FIG. 10 is a diagram illustrating operations in this embodiment. In the first embodiment, the determination has been made based only on whether or not the power cable is connected; meanwhile, in this embodiment, determination is made by acquiring a wheel locking state as another different state and using the multiple states in combination.

Here, as the wheel locking state, the controller 100 can acquire information on whether or not the wheel 56 or the wheels 55 are locked. Alternatively, the locking of the wheels may be implemented by another braking mechanism different from the wheels 55 and the wheel 56. In this case, the controller 100 may acquire a state of the braking mechanism. Specifically, the controller 100 may acquire information that the wheels are locked in a state where the braking of the braking mechanism is actuated, and acquire information that the wheels are unlocked in a state where the braking of the braking mechanism is released.

A description will be given using FIG. 10. FIG. 10 illustrates a case in which, in this embodiment, determination is made using conditions of “caster lock” “caster unlock” in addition to the condition on whether or not the power cable is connected in the first embodiment.

For example, when the power cable is connected, the controller 100 prohibits an operation of the first operation device 20 irrespective of whether the wheels are locked or unlocked. For example, the controller 100 does not cause the state of the bed apparatus 5 to transition to the state of S50 in FIG. 7.

Then, when the power cable is disconnected, the controller 100 acquires the wheel locking state. Here, the controller 100 may display a warning message when the wheels are locked. In other words, the controller 100 does not necessarily have to cause the state to transition to the state of S50 in FIG. 7 or the first level state (S40). In addition, the controller 100 may cause the state of the bed apparatus 5 to transition to the operation prohibited state (S16) before displaying the warning message indicating that the wheels are locked.

Meanwhile, when the power cable is not connected and the wheels are unlocked, the controller 100 causes the state of the bed apparatus 5 to transition to the operation prohibited state (S16).

In this manner, according to this embodiment, it is possible to decide the state of the bed apparatus 5 by acquiring the multiple states and using the multiple states in combination, and therefore possible to control the bed apparatus 5 more safely.

In particular, in a case where the operator tries to transport the bed apparatus 5 while forgetting to release the lock (caster lock) of the wheel 56, this embodiment brings about an effect of preventing the operator from erroneously judging that the bed apparatus 5 does not move due to a failure of the bed apparatus 5. This embodiment also brings about an effect of preventing the transportation driving unit 37 (transportation device) from overheating due to overload because the operator tries to forcibly move the bed apparatus 5 and thereby preventing the controller 100 from determining overheating anomaly.

### 3. Third Embodiment

A third embodiment will be described. In the first embodiment, the specific state of the bed apparatus 5 has been described as the state in which the power cable is connected. In this embodiment, a description will be given of a case of acquiring the environment of the bed apparatus 5 and determining, based on the environment of the bed apparatus 5, whether the bed apparatus 5 is in a specific state wherein the specific state refers to a state in which the bed apparatus 5 is immovable.

Note that, the functions and configurations of the third embodiment are the same as those having been described in the first embodiment and therefore detailed description thereof will be omitted. Hereinbelow, the contents specific to this embodiment will be mainly described.

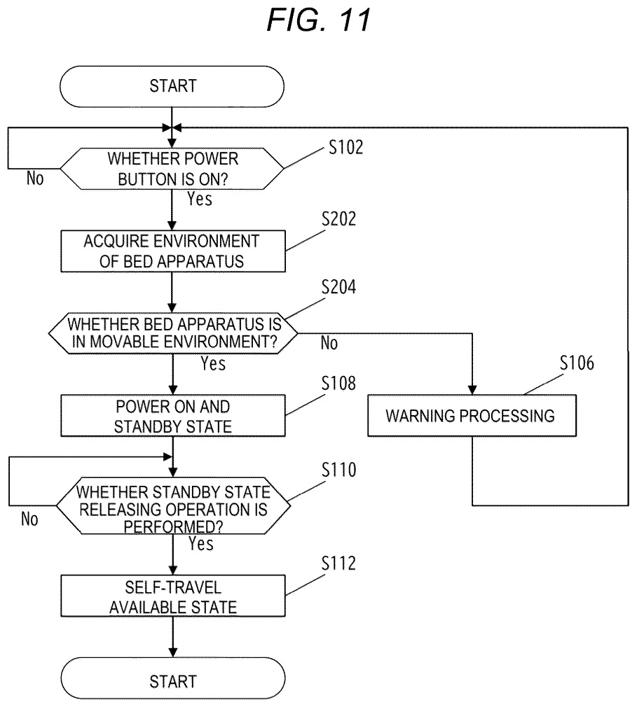

FIG. 11 is a diagram obtained by replacing the processing flow having been described in FIG. 8 of the first embodiment. In this embodiment, once the power button B24 is selected, the controller 100 acquires the environment of the bed apparatus 5 (S102; Yes−>S202).

Then, based on the environment of the bed apparatus 5, the controller 100 determines whether or not the bed apparatus 5 is in a movable environment (S204). If the bed apparatus 5 is in a movable environment, the controller 100 powers on the bed apparatus and causes the state to transition to the standby state (S204; Yes−>S108). On the other hand, if the bed apparatus 5 is not in a movable environment, the controller 100 may display a warning message (S204; No−>S106). In other words, in this embodiment, if the bed apparatus 5 is not in a movable environment, the controller 100 determines that the bed apparatus 5 is in the specific state.

Here, for example, the following combinations are conceivable as combinations between information that can be acquired as the environment of the bed apparatus 5 and the environment under which the controller 100 determines that the bed apparatus is not movable (the environment that the controller determines that the bed apparatus 5 is in the specific state).

### (1) External Cable Is Connected

For example, the controller 100 determines whether a cable other than the power cable is connected to the bed apparatus 5. Here, examples of cables to be connected to the bed apparatus 5 include, besides the cable connected to the control device 10, a cable connected to the user of the bed apparatus 5 and a cable connected to the mattress 3.

For example, when an intravenous drip tube or an infusion pump is connected to the user, the controller 100 determines that the bed apparatus 5 is in the specific state and the bed apparatus 5 is not in a movable environment.

In addition, when a nurse call cable is connected to the periphery of the bed apparatus 5, the controller 100 may determine that the bed apparatus 5 is not movable.

Here, the state where a cable and the like is connected to the bed apparatus 5 includes, in addition to the case where the cable is connected to the connector, a case where the cable is fixed on the bed apparatus 5 using an instrument, a case where the cable is pinched below the mattress 3, a case where the cable is hung on side rails of the bed apparatus 5, a case where the cable is held by the user, and the like, for example.

When the external cable is connected, the controller 100 determines that the bed apparatus 5 is in the specific state and is not movable.

For determining whether or not the external cable is connected, for example, the controller 100 may detect a connection signal output when the external cable is connected. Alternatively, the controller 100 may determine whether the external cable is connected by shooting the peripheral environment of the bed apparatus 5 by a camera and conducting an image analysis. Still alternatively, the controller 100 may determine whether the external cable is connected based on information input by the operator, the staff, or the user.

### (2) Another Instrument or Device Exists Near Bed Apparatus 5

For example, the controller 100 acquires whether a side table is used in the bed apparatus 5. When the side table is used in the bed apparatus 5, the controller 100 determines that the bed apparatus 5 is in the specific state and is not movable.

Further, the controller 100 may determine that the bed apparatus is not movable when a device such as an overbed table, a lift device, or a bedpan other than the side table exists.

The controller 100 may determine whether another instrument or device exists near the bed apparatus 5 by shooting the peripheral environment of the bed apparatus 5 using a camera and analyzing the image. Alternatively, the controller 100 may determine whether another instrument or device exists near the bed apparatus based on information input by the operator, the staff, or the user.

### (3) Obstacle Exists on Movement Route

For example, when an obstacle exists in the movement direction, the controller 100 determines that the bed apparatus 5 is in the specific state and is not movable. For example, the controller 100 may acquire whether a chair, a wheelchair, an emergency cart, a medication cart, or the like exists as the obstacle. As described previously, the controller 100 may determine whether or not the obstacle exists based on an image shot by a camera or information input by the operator or the like.

### (4) Acquire Environment (Situation) of Bed Apparatus 5

For example, the controller 100 acquires the environment and situation of the bed apparatus 5. For example, as the environment of the bed apparatus 5, the controller 100 acquires the state of the sections (such as a back raising angle and an upper-leg raising angle) and the state of the mattress 3 (such as the internal pressure of the air mattress and whether or not a rolling function is executed). Then, the controller 100 may determine that the bed apparatus 5 is movable when the sections are flat (or substantially flat). In other words, the controller 100 determines a state in which the sections are not flat as the specific state. As a method of acquiring the state of the sections of the bed apparatus 5 and the state of the mattress 3, the controller 100 may acquire signals indicating the states from any device.

In this manner, according to this embodiment, the bed apparatus 5 does not accept any operation by the first operation device 20 when the bed apparatus is in an environment where it cannot be moved safely due to reasons including the power cable, so that the bed apparatus 5 with higher safety can be provided.

### 4. Fourth Embodiment

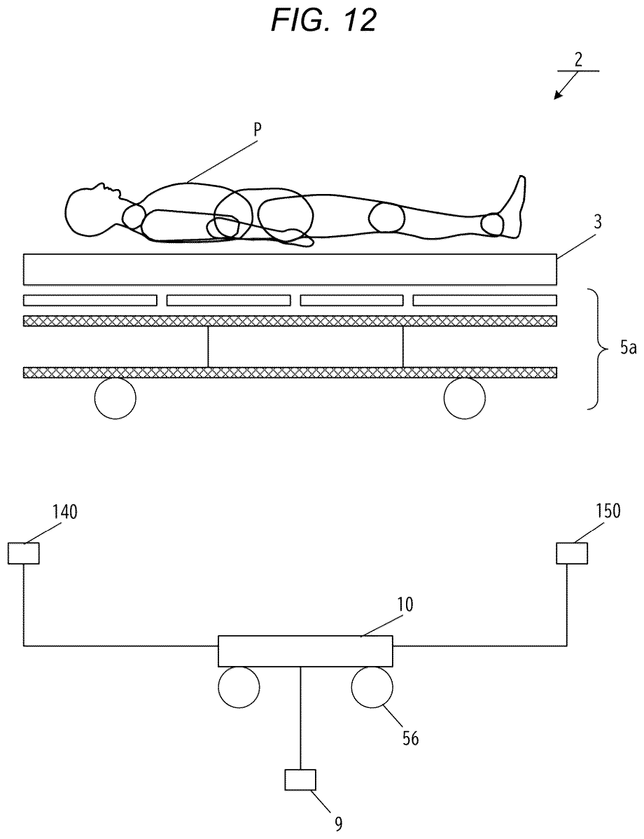

Subsequently, a fourth embodiment will be described. The fourth embodiment is an embodiment in which the transportation device is installed on an existing bed apparatus afterwards. FIG. 12 is a view illustrating an example of a system 2 in the embodiment. A bed apparatus 5a of the system 2 is an existing bed apparatus and is not provided with the control device 10 having the transportation function of this disclosure.

The control device 10 is attached afterwards on the bed apparatus 5a not having the control device 10. For example, the control device 10 is attached to the lower frame, for example. Here, the control device 10 is attached to a position where the wheel 56 connected to the control device 10 is in contact with the ground. In addition, the control device 10 is provided, by wired or wireless, with the first connection unit 140 and the second connection unit 150 to which the first operation device 20 is connected. The first connection unit 140 is provided on the head-side lower frame or upper frame of the bed apparatus 5a, for example, whereas the second connection unit 150 is provided on the foot-side lower frame or upper frame of the bed apparatus 5a, for example. Note that, the number of connection units to which the first operation device 20 can be connected is not limited to two and may be more than two. In addition, power is supplied to the control device 10 from the external power source 9 via a power cable, so that the rechargeable battery of the control device 10 can be charged.

The functions having been described in the above embodiments can be thereby implemented in the existing bed apparatus easily.

### 5. Modified Examples

The present disclosure is not limited to each of the above-described embodiments, and various modifications can be made thereto.

That is, embodiments that can be implemented by combining technical means appropriately modified within the scope that does not depart from the gist of the present disclosure are also included in the technical scope.

In the above-described embodiments, the description has been given of the case where the transportation device is mainly applied to the bed apparatus, but apparatuses to which the transportation device is applied are not limited to the bed apparatus. For example, the bed apparatus also includes a home use bed and a stretcher in addition to a hospital bed and a care bed. In addition, in terms of an apparatus that can travel by itself, the transportation device is also applicable to apparatuses such as a cart and a wheelchair.

The above-described embodiments are divided for convenience of the description. However, the embodiments can be combined and implemented within the realm of possibility. It is also intended to acquire the rights to any of the techniques described in the present specification in the forms of an amendment, a divisional application, and the like.

Moreover, the program that operates in each device in the respective embodiments is a program that controls a CPU or the like (a program that causes a computer to function) so as to implement the functions in the abovementioned embodiments. Further, the information that is handled by these devices is temporarily stored in a temporary storage (for example, RAM) at the time of processing, and thereafter stored in various ROM and HDD storage devices, and is read and corrected/written by the CPU as necessary.

Herein, as a recording medium that stores the program, any of a semiconductor medium (for example, a ROM and a nonvolatile memory card), an optical recording medium, a magneto-optical recording medium (for example, a digital versatile disc (DVD), a compact disc (CD), and a Blu-ray (registered trademark) disc (BD)), a magnetic recording medium (for example, a magnetic tape and a flexible disc), and the like may be used.

Further, in a case of distribution to the market, the program can be stored and distributed in a portable recording medium, or transferred to a server computer connected via a network such as the Internet. In this case, a storage device of the server device, of course, falls within the present disclosure.

The above-described data is not stored in the device, but may be stored in an external device, and called, as appropriate. For example, data may be stored in a network attached storage (NAS), or stored on a cloud.

The respective functional blocks or various features of the devices used in the above-described embodiments can be implemented or executed by an electric circuit, for example, an integrated circuit or multiple integrated circuits. Electric circuits designed to execute the functions described in the present specification may include general purpose processors, digital signal processors (DSPs), application specific integrated circuits (ASICs), field programmable gate arrays (FPGAs), or other programmable logic devices, discrete gate or transistor logic, discrete hardware components, or combinations thereof. The general purpose processor may be a microprocessor or a processor, a controller, a microcontroller, or a state machine of the related art. The above-described electric circuit may be implemented by a digital circuit or may be implemented by an analog circuit. In a case where a technology of integrating circuits that replaces the current integrated circuit appears due to the progress of the semiconductor technology, one or more aspects in the present disclosure can also use a new integrated circuit based on the technology.

The scope of the present disclosure is not limited to the configurations that are explicitly described in the present disclosure, and includes combinations of the techniques disclosed in the present disclosure. In the present disclosure, the configurations, for which the applicant attempts to acquire a patent, are described in the claims. However, it is not intended that the configuration not described in the claims is excluded from the technical scope.

In the above-described specification, each of the expressions such as “in the case where . . . ” and “when . . . ” only represents one example, and thus the present disclosure is not limited to the contents described above. Configurations not described with these expressions are also disclosed within the scope that is apparent for those skilled in the art, and it is intended to acquire the rights to such configurations.

Orders of the processing and the data flow described in the present specification are not limited to the described orders. For example, the configuration in which the processing is partially omitted and the configuration in which the order of the processing is changed are also disclosed, and it is intended to acquire the right therefor.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A bed apparatus comprising:
a wheel;
a driving unit configured to transmit a driving force to the wheel;
a user interface device; and
a controller configured to control the driving unit according to an operation by the user interface device, wherein
the controller is configured to
acquire a state of the bed apparatus, and
restrict acceptance of an operation by the user interface device when the state of the bed apparatus thus acquired is a specific state.

2. The bed apparatus according to claim 1, further comprising a connector, wherein
as the state of the bed apparatus, the controller is configured to acquire a state in which a cable is connected to the connector as the specific state.

3. The bed apparatus according to claim 1, further comprising:
a rechargeable battery;
a connector; and
a charger that is supplied with power from an external power source through a cable connected to the connector, the charger being configured to charge the rechargeable battery using the power supplied to the connector, wherein
as the state of the bed apparatus, the controller is configured to acquire a state in which the charging unit is charging as the specific state.

4. The bed apparatus according to claim 1, wherein
the bed apparatus includes one or a plurality of sections,
a back raising function or an upper-leg raising function is implemented by turning of the sections, and
as the state of the bed apparatus, the controller is configured to acquire a state, other than a state in which a shape of the sections is flat, as the specific state.

5. The bed apparatus according to claim 1, further comprising:
an environment acquisition unit configured to acquire a peripheral environment of the bed apparatus, wherein
as the state of the bed apparatus, the controller is configured to acquire a state, in which an object being an obstacle exists when the bed apparatus moves, as the specific state based on the peripheral environment acquired by the environment acquisition unit.

6. A transportation device attachable to a bed apparatus, the transportation device comprising:
a wheel;
a driving unit configured to transmit a driving force to the wheel;
a user interface device; and
a controller configured to control the driving unit according to an operation by the user interface device, wherein
the controller is configured to
acquire a state of the bed apparatus, and
restrict acceptance of an operation by the user interface device when the state of the bed apparatus thus acquired is a specific state.
